(19) United States
(12) Patent Application Publication
(10) Pub. No.: US 2019/0362085 A1
(43) Pub. Date: Nov. 28, 2019

(54) LADDER PROGRAM UNAUTHORIZED-USE PREVENTION SYSTEM AND LADDER PROGRAM UNAUTHORIZED-USE PREVENTION METHOD

(71) Applicant: Mitsubishi Electric Corporation, Tokyo (JP)

(72) Inventors: Takashi YUGUCHI, Tokyo (JP); Daisuke SUZUKI, Tokyo (JP)

(73) Assignee: Mitsubishi Electric Corporation, Tokyo (JP)

(21) Appl. No.: 16/463,386

(22) PCT Filed: Jun. 23, 2017
(86) PCT No.: PCT/JP2017/023222

§ 371 Date: May 23, 2019

(51) Int. Cl. G06F 21/62; G06F 21/12; G06F 17/50; H04L 9/32

(52) U.S. Cl. CPC G06F 21/629; H04L 9/3263; G06F 17/5009; G06F 21/12

(57) ABSTRACT

A ladder program unauthorized-use prevention system includes an engineering tool to decode a ladder program encrypted using a vendor private key, using a vendor public key paired with the vendor private key, and to encrypt the decoded ladder program using a controller public key such that the ladder program is operable on a specific programmable controller but is inoperable on other programmable controllers, and a programmable controller to decode the ladder program encrypted using the controller public key, using a controller private key paired with the controller public key, and to execute the ladder program decoded using the controller private key.

### FIELD

The present invention relates to a ladder program unauthorized-use prevention system that delivers a ladder program for operating a programmable controller, to a ladder program unauthorized-use prevention method, to an engineering tool, to a license delivery server, and to a programmable controller.

### BACKGROUND

A ladder program installed in a programmable controller is an essential design asset, and therefore needs to be protected from a malicious third party by a security function. One example of typical protection method is access control using a password in reading or writing a ladder program performed by the programmable controller.

Patent Literature 1 discloses a program protection method using a dedicated protection instruction in a ladder program. This program protection method specifies a protection range in the ladder program as desired by a protection instruction and by a protection end instruction.

### CITATION LIST

### Patent Literature

Patent Literature 1: Japanese Patent Application Laid-open No. H10-124308

### SUMMARY

### Technical Problem

However, the above conventional technology disclosed in Patent Literature 1 fails to suitably protect a ladder program contained in a packaged product including a programmable controller and a peripheral device in combination, i.e., a ladder program installed in a programmable controller. This is because the technology described in Patent Literature 1 can protect only a ladder program used alone, but fails to protect the ladder program contained in a packaged product by permitting the ladder program to run on only a specific programmable controller. This presents a problem in that a programmable controller unauthorized to use the ladder program can also use the ladder program without authorization.

The present invention has been made in view of the foregoing, and it is an object of the present invention to provide a ladder program unauthorized-use prevention system capable of preventing unauthorized use of a ladder program, for example, delivered in a state contained in a commercial packaged product.

### Solution to Problem

To solve the problem and achieve the object described above, an aspect of the present invention is directed to a ladder program unauthorized-use prevention system including: an engineering tool to perform a first inverse transformation on a ladder program that undergoes a first transformation using first private information, using first public information paired with the first private information, and perform a second transformation, using second public information, on the ladder program that undergoes the first inverse transformation such that the ladder program is operable on a specific programmable controller but is inoperable on a programmable controller other than the specific programmable controller. The ladder program unauthorized-use prevention system of the present invention further includes a programmable controller to perform a second inverse transformation on the ladder program that undergoes the second transformation, using second private information paired with the second public information, and execute the ladder program that undergoes the second inverse transformation.

### Advantageous Effects of Invention

A ladder program unauthorized-use prevention system, a ladder program unauthorized-use prevention method, an engineering tool, a license delivery server, and a programmable controller according to the present invention provide an advantage in that unauthorized use of a ladder program delivered can be prevented.

### BRIEF DESCRIPTION OF DRAWINGS

FIG. 1 is a diagram illustrating a configuration of a ladder program unauthorized-use prevention system according to a first embodiment.

FIG. 2 is a block diagram illustrating an example configuration of the license delivery server according to the first embodiment.

FIG. 3 is a block diagram illustrating an example functional configuration of the engineering tool according to the first embodiment.

FIG. 4 is a block diagram illustrating an example configuration of the programmable controller according to the first embodiment.

FIG. 5 is a flowchart illustrating an operation procedure performed by the ladder program unauthorized-use prevention system according to the first embodiment.

FIG. 6 is a diagram illustrating a hardware configuration of the ladder program unauthorized-use prevention system according to the first embodiment.

FIG. 7 is a diagram for describing a process performed by a license delivery server according to a second embodiment.

FIG. 8 is a diagram for describing a process performed by an engineering tool according to the second embodiment.

FIG. 9 is a diagram for describing a simulation process of a function block (FB) performed by the engineering tool according to the second embodiment.

### DESCRIPTION OF EMBODIMENTS

A ladder program unauthorized-use prevention system, a ladder program unauthorized-use prevention method, an engineering tool, a license delivery server, and a programmable controller according to embodiments of the present invention will be described in detail below with reference to the drawings. Note that these embodiments are not intended to limit this invention.

### First Embodiment

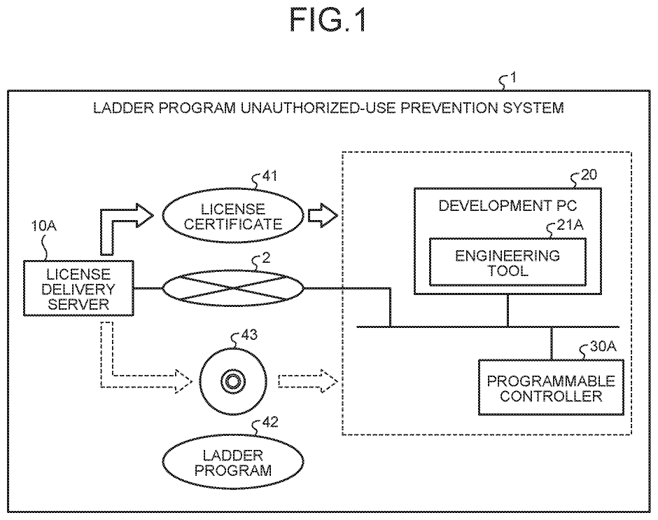

FIG. 1 is a diagram illustrating a configuration of a ladder program unauthorized-use prevention system according to a first embodiment. A ladder program unauthorized-use prevention system 1 according to the first embodiment is a system that delivers a ladder program 42 contained in a packaged product to an external device such as a programmable controller 30A. The packaged product is a group of products offered by a vendor, i.e., a seller, to a user, i.e., a purchaser. As the packaged product, the programmable controller 30A, a peripheral device, and the ladder program 42 for controlling these devices are sold in a bundle. Examples of the peripheral device include an input-output (IC) unit and a power supply unit.

The ladder program unauthorized-use prevention system 1 includes a license delivery server 10A managed by the vendor of the packaged product; the programmable controller 30A, which is a part of the packaged product; and a development personal computer (PC) 20 for use in development by the user to make the programmable controller 30A operable. The license delivery server 10A, the development PC 20, and the programmable controller 30A are connected to the Internet 2. The development PC 20 and the programmable controller 30A are also connected to a network owned by the user. Note that the programmable controller 30A may not necessarily be connected to the Internet 2. Although FIG. 1 illustrates the Internet 2 in the ladder program unauthorized-use prevention system 1, the ladder program unauthorized-use prevention system 1 does not include the Internet 2.

One example of the license delivery server 10A is a server PC. The development PC 20 includes an engineering tool 21A for development of the ladder program 42, which is used by the programmable controller 30A.

The engineering tool 21A is an example of engineering environment for development of the ladder program 42, and it is also referred to as engineering environment software. The engineering tool 21A, which is an application program, is installed in the development PC 20 and runs on the development PC 20.

The programmable controller 30A is connected to a control target device (not illustrated), such as a sensor or a robot. The programmable controller 30A controls the control target device using the ladder program 42. The programmable controller 30A is also referred to as programmable logic controller (PLC).

The vendor of the packaged product writes the ladder program 42 that enables the programmable controller 30A to control the control target device into a portable recording medium 43 such as a digital versatile disc (DVD) for delivery to the user. The vendor also delivers a license certificate 41 to the user, for example, via the Internet 2 or by mail. The license certificate 41 contains information on license for the programmable controller 30A, which is a specific programmable controller. The license certificate 41 contains information on the expiration time of the license, information on features available in the packaged product, and the public key assigned to the programmable controller 30A that is the issuance target.

The ladder program unauthorized-use prevention system 1 of the first embodiment wholly protects a delivery process of the ladder program 42, an edit process in the engineering environment of the user, a simulation process in the engineering environment of the user, and an embedding process into the programmable controller 30A.

Limiting conditioning for providing protection for the ladder program 42 contained in the packaged product will now be described.

<1> The ladder program 42 contained in the packaged product that has been sold is operable on the specific programmable controller 30A, but does not operate on a programmable controller other than the programmable controller 30A.

<2> The ladder program unauthorized-use prevention system 1 issues the license certificate 41 to a user on a per-user basis.

<3> The ladder program unauthorized use prevention system 1 delivers the ladder program 42 to a user via the recording medium 43 or online via the Internet 2.

<4> A portion of the ladder program 42 under protection may be edited by a user using the engineering tool 21A.
<5> The ladder program 42 under protection includes a non-user-editable portion called function block.

<6> A user may perform a simulation, which is a process of virtually operating the ladder program 42 on the engineering tool 21A.

In the ladder program unauthorized-use prevention system 1, the license delivery server 10A delivers the ladder program 42, which is user-specific, on a per-user basis under the limiting conditions <1> to <6> described above. Note that, as described in the condition <3>, the ladder program unauthorized-use prevention system 1 may deliver the ladder program 42 online, but the description below assumes that the license delivery server 10A delivers the ladder program 42 via the recording medium 43.

The pubic keys and the private keys used by the ladder program unauthorized-use prevention system 1 will next be described. The ladder program unauthorized-use prevention system 1 uses a vendor private key Vsec that is first private information; an engineering environment public key Epub_1; a vendor public key Vpub that is first public information; an engineering environment private key Esec; a controller public key Cpub that is second public information; an engineering environment public key Epub_2; and a controller private key Csec that is second private information.

<Vendor Private Key Vsec>

The vendor private key Vsec is a private key used by the license delivery server 10A, which is a vendor. The license delivery server 10A uses the vendor private key Vsec in providing the ladder program 42 to the engineering tool 21A. Specifically, the license delivery server 10A uses the vendor private key Vsec in encrypting the ladder program 42.

<Engineering Environment Public Key Epub_1>

The engineering environment public key Epub_1 is a public key used by the license delivery server 10A. The license delivery server 10A uses the engineering environment public key Epub_1 in providing the ladder program 42 to the engineering tool 21A. Specifically, the license delivery server 10A uses the engineering environment public key Epub_1 in encrypting the ladder program 42.

<Vendor Public Key Vpub>

The vendor public key Vpub is a public key used by the engineering tool 21A. The engineering tool 21A uses the vendor public key Vpub in obtaining the ladder program 42 from the license delivery server 10A. Specifically, the engineering tool 21A uses the vendor public key Vpub in decoding delivery file data 101 (described later herein), which is the ladder program 42 that has been encrypted. The vendor public key Vpub forms a pair with the vendor private key Vsec. Thus, it can also be said that the relationship between the vendor public key Vpub and the vendor private key Vsec is shared between the license delivery server 10A and the engineering tool 21A.

<Engineering Environment Private Key Esec>

The engineering environment private key Esec is a private key used by the engineering tool 21A. The engineering tool 21A uses the engineering environment private key Esec in obtaining the ladder program 42 from the license delivery server 10A. Specifically, the engineering tool 21A uses the engineering environment private key Esec in decoding the delivery file data 101. The engineering environment private key Esec forms a pair with the engineering environment public key Epub_1. Thus, it can also be said that the relationship between the engineering environment private key Esec and the engineering environment public key Epub_1 is shared between the license delivery server 10A and the engineering tool 21A.

<Controller Public Key Cpub>

The controller public key Cpub is a public key used by the engineering tool 21A. The engineering tool 21A uses the controller public key Cpub in providing the ladder program 42 to the programmable controller 30A. Specifically, the engineering tool 21A uses the controller public key Cpub in transforming an executable file 201 (described later herein) that has been decoded by the engineering tool 21A, into a file operable on only the programmable controller 30A.

<Engineering Environment Public Key Epub_2>

The engineering environment public key Epub_2 a public key used by the programmable controller 30A. The programmable controller 30A uses the engineering environment public key Epub_2 obtaining the executable file 201 of the ladder program 42 from the engineering tool 21A. Specifically, the programmable controller 30A uses the engineering environment public key Epub_2 in decoding a protected executable file 202 (described later herein), which is the executable file 201 that has been encrypted.

<Controller Private Key Csec>

The controller private key Csec is a private key used by the programmable controller 30A. The programmable controller 30A uses the controller private key Csec in obtaining the executable file 201 of the ladder program 42 from the engineering tool 21A. Specifically, the programmable controller 30A uses the controller private key Csec in decoding the protected executable file 202, which is a protected file. The controller private key Csec forms a pair with the controller public key Cpub. Thus, it can also be said that the relationship between the controller private key Csec and the controller public key Cpub is shared between the engineering tool 21A and the programmable controller 30A.

The vendor, i.e., the seller, installs private information such as private keys and public information such as public keys in the engineering tool 21A and in the programmable controller 30A before selling the above packaged product to a user, i.e., a purchaser. In this operation, the license delivery server 10A delivers the second private information described above and the first public information described above to the specific engineering tool 21A, and the second public information described above to the specific programmable controller 30A.

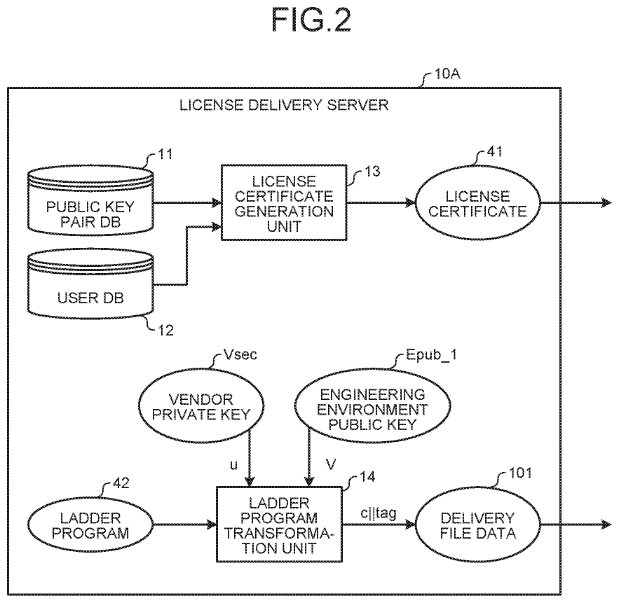

An example configuration of the license delivery server 10A will next be described. FIG. 2 is a block diagram illustrating an example configuration of the license delivery server according to the first embodiment. The license delivery server 10A includes a public key pair database (DB) 11 that stores public key pairs, each of which is a pair of a public key and a private key, and a user DB 12 that stores user information, which is information on the user.

The license delivery server 10A further includes a license certificate generation unit 13 that generates the license certificate 41, and a ladder program transformation unit 14 that transforms the ladder program 42 into the delivery file data 101. The delivery file data 101 is a file generated by encrypting the ladder program 42 that the vendor provides to the user. Thus, the delivery file data 101 is file data of the ladder program 42, made secure by the license delivery server 10A. The license delivery server 10A further includes a memory (not illustrated) that stores the vendor private key Vsec, the engineering environment public key Epub_1, and the ladder program 42.

The public key pair DB 11 stores public key pairs assigned to multiple programmable controllers including the programmable controller 30A and one or more programmable controllers other than this. In other words, the public key pair DB 11 stores a pair of a public key and a private key for each of the programmable controllers 30A. The public key stored in the public key pair DB 11 is the controller public key Cpub described later, and the private key stored in the public key pair DB 11 is the controller private key Csec described later.

The user DB 12 stores user information that associates the user having purchased a license of the packaged product with device information on the programmable controller 30A contained in the packaged product supplied to the user.

The license certificate generation unit 13, which is a license generation unit, is connected to the public key pair DB 11 and to the user DB 12. The license certificate generation unit 13 generates the license certificate 41 for the user on the basis of a public key pair in the public key pair DB 11 and the user information in the user DB 12. Specifically, the license certificate generation unit 13 reads, from the user DB 12, the device information on the programmable controller 30A that is the issuance target of the license certificate 41. The license certificate generation unit 13 also reads, from the public key pair DB 11, the public key pair assigned to the device information that has been read. The license certificate generation unit 13 incorporates, into the license certificate 41, information on the expiration time of the license, information on features available in the packaged product, and the public key pair assigned to the programmable controller 30A that is the issuance target.

The license certificate generation unit 13 delivers the license certificate 41 to the user via an electronic medium such as an electronic mail (e-mail) or via a paper medium. If the license certificate 41 is to be delivered using an electronic medium, the license certificate generation unit 13 generates an e-mail having a file of the license certificate 41 attached thereto. Thus, the license delivery server 10A sends the e-mail generated by the license certificate generation unit 13 to the user. Otherwise, if the license certificate 41 is to be delivered using a paper medium, the license delivery server 10A outputs data for printing out the license certificate 41 on a paper medium, to a printer (not illustrated). Then, the printer prints out the license certificate 41 to complete the license certificate 41 on a paper medium. The license certificate 41 on a paper medium is then delivered to the user by a delivery method such as by mail.

The ladder program transformation unit 14 uses the vendor private key Vsec and the engineering environment public key Epub_1 to perform a first transformation oil the ladder program 42. Specifically, the ladder program transformation unit 14 uses a key derivation function (KDF), which is a function of key derivation, an encryption function Enc, and a tamper detection code generation function MAC to transform the ladder program 12 into the delivery file data 101 for user delivery. The KDF is a function of deriving a private key. The encryption function Enc is a function of performing encryption. The tamper detection code generation function MAC is a function of generating a tamper detection code for message authentication.

The ladder program transformation unit 14 generates a key for encryption and a key for tamper detection from the vendor private key Vsec and from the engineering environment public key Epub_1 using the KFDF. The key for encryption generated by the ladder program transformation unit 14 is a temporary key for encryption, and the key for tamper detection is a temporary key for tamper detection. The vendor private key Vsec is a private key specific to the vendor supplying the packaged product. The engineering environment public key Epub_1 is an encryption key for keeping the vendor private key Vsec secret. In addition, the ladder program transformation unit 14 uses the key for encryption and the key for tamper detection that have been generated, to transform the ladder program 42 into the delivery file data 101. The ladder program 42 is a set of a portion that a user is allowed to edit and a function block, which is a functional unit not intended to be edited by a user. The license delivery server 10A writes the delivery file data 101 into the recording medium 43.

An operation of the license delivery server 10A will next be described. The license delivery server 10A preparatorily stores the public key parr in the public key pair DB 11 and stores the user information in the user DB 12.

The license certificate generation unit 13 generates the license certificate 41 for the user on the basis of a public key pair in the public key pair DB 11 and the user information in the user DB 12. In this operation, the license certificate generation unit 13 reads user-specific device information from the user DB 12, and the license certificate generation unit 13 reads, from the public key pair DB 11, the public: key pair assigned to the device information that has been read. The license certificate generation unit 13 then incorporates, into the license certificate 41, information on the expiration time of the license, information on features available in the packaged product, and the public key pair assigned to the programmable controller 30A that is the issuance target.

Meanwhile, the ladder program transformation unit 14 generates the key for encryption and the key for tamper detection from the vendor private key Vsec and the engineering environment public key Epub_1 using the KDF, which is a key derivation function. That is, the ladder program transformation unit 14 performs processing (1) below using the encryption key Kenc and the key for tamper detection (hereinafter also referred to as tamper detection key) Kmac, where u represents the vendor private key Vsec and V represents the engineering environment public key Epub_1. In the description below, the symbol ∥ is used to represent bit concatenation.

KDF(uV)→Kmac∥Kenc (1)

Note that the symbol “→” in each description of processing in the first embodiment represents data derivation processing. Specifically, the ladder program unauthorized-use prevention system 1 performs the processing described on the left side of the symbol “→” to derive data described on the right side of the symbol “→”.

Note that it is assumed here that a relationship of uV=vU holds, where U represents the vendor public key Vpub and v represents the engineering environment private key Esec. One example of the KDF is the KDF used in RFC 2898, PKCS #5: Password-Based Cryptography Specification, Version 2.0.

Then, the ladder program transformation unit 14 performs encryption processing and tamper detection code addition processing on the ladder program 42 containing a function block. That is, the ladder program transformation unit 14 performs processing (2) and processing (3) below respectively using the encryption function Enc and the tamper detection code generation function MAC, where m represents the ladder program 42.

Enc(Kenc, m)→c (2)

MAC(Kmac, c)→tag (3)

In the above representations, “c” represents the file generated by encrypting the ladder program 42 using the encryption key and “tag” represents the tamper detection code generated by applying the tamper detection key to c. The ladder program transformation unit 14 uses c∥tag as the delivery file data 101. The license delivery server 10A then writes the delivery file data 101 into the recording medium 43. Then, the recording medium 43 storing the delivery file data 101 is delivered to the user by the vendor.

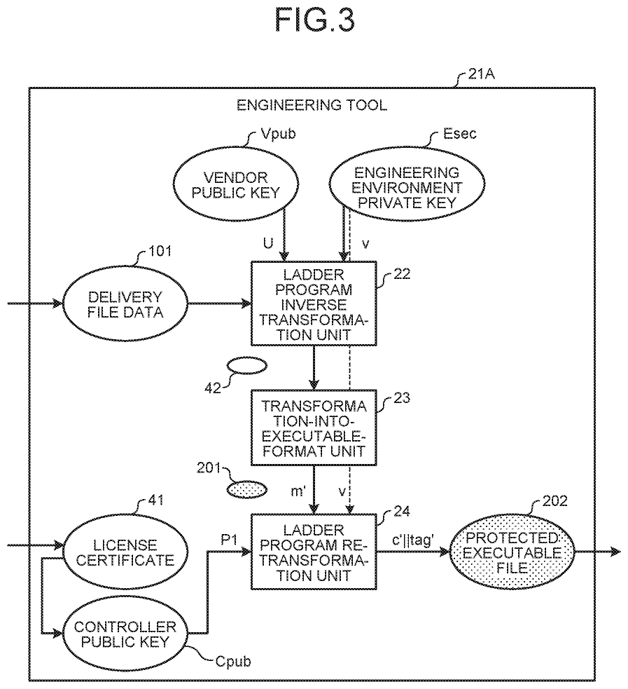

An example functional configuration of the engineering tool 21A will next be described. FIG. 3 is a block diagram illustrating an example functional configuration of the engineering tool according to the first embodiment. The engineering tool 21A includes a ladder program inverse transformation unit 22 that inverse-transforms the delivery file data 101 delivered from the license delivery server 10A into the ladder program 42 before encryption, and a transformation-into-executable-format unit 23 that transforms the ladder program 42 into the executable file 201. The executable file 201 is an executable file recognized by the programmable controller 30A as a program. The engineering tool 21A further includes a ladder program re-transformation unit 24 that transforms the executable file 201 into a file operable on only the programmable controller 30A.

The engineering tool 21A further includes a memory (not illustrated) that stores the vendor public key Vpub and the engineering environment private key Esec. The engineering tool 21A reads the delivery file data 101 and the license certificate 41 each delivered from the license delivery server 10A from a memory in the development PC 20, and performs various processing. The vendor public key Vpub is a public key specific to the vendor supplying the packaged product, and forms a pair with the vendor private key Vsec. That is, data that has been encrypted using the vendor private key Vsec can be decoded using the vendor public key Vpub. The engineering environment private key Esec is a private key specific to the engineering tool 21A embedded in the engineering tool 21A, and forms a pair with the engineering environment public key Epub_2. That is, data that has been encrypted using the engineering environment private key Esec can be decoded using the engineering environment public key Epub_2.

The ladder program inverse transformation unit 22 performs a first inverse transformation on the delivery file data 101 using the vendor public key Vpub and the engineering environment private key Esec. That is, the ladder program inverse transformation unit 22 performs inverse transformation, i.e., decoding, using the vendor public key Vpub and the engineering environment private key Esec each previously embedded in the engineering tool 21A. Specifically, the ladder program inverse transformation unit 22 inverse-transforms the delivery file data 101 into the ladder program 42 before encryption using the vendor public key Vpub and the engineering environment private key Esec. That is, the ladder program inverse transformation unit 22 decodes the ladder program 42 that has been encrypted, thus to obtain the ladder program 42. The ladder program inverse transformation unit 22 sends the ladder program 42 generated by the inverse transformation to the transformation-into-executable-format unit 23.

The transformation-into-executable-format unit 23 transforms the ladder program 42 generated by the inverse transformation performed by the ladder program inverse transformation unit 22 into the executable file 201. The transformation-into-executable-format unit 23 sends the executable file 201 generated by the transformation to the ladder program re-transformation unit 24.

The ladder program re-transformation unit 24 performs a second transformation on the executable file 201 using the controller public key Cpub. Specifically, the ladder program re-transformation unit 24 transforms the executable file 201 generated by the transformation performed by the transformation-into-executable-format unit 23 into a file operable on only the programmable controller 30A associated with the license certificate 41. The file operable on only the programmable controller 30A associated with the license certificate 41 is the protected executable file 202. The protected executable file 202 is protected such that it cannot be operated in a programmable controller other than the programmable controller 30A. The protected executable file 202 is an executable file recognized by the programmable controller 30A as a program. The engineering tool 21A sends the protected executable file 202 generated by the ladder program re-transformation unit 24 to the programmable controller 30A.

An operation of the engineering tool 21A will next be described. The development PC 20 preparatorily stores, in a memory thereof (not illustrated), the delivery file data 101 and the license certificate 41 delivered from the license delivery server 10A.

Then, the ladder program inverse transformation unit 22 of the engineering tool 21A reads the delivery file data 101 delivered from the license delivery server 10A from the memory, and inverse-transforms the delivery file data 101 into the ladder program 42 before encryption. In this operation, the ladder program inverse transformation unit 22 performs inverse transformation, i.e., decoding, using the vendor public key Vpub and the engineering environment private key Esec previously embedded in the engineering tool 21A. That is, the ladder program inverse transformation unit 22 performs processing (4) below, where U represents the correct vendor public key Vpub and v represents the engineering environment private key Esec.

KDF(vU)→Kmac∥Kenc (4)

This enables the ladder program inverse transformation unit 22 to reproduce the encryption key Kenc and the tamper detection key Kmao generated by the license delivery server 10A. The ladder program inverse transformation unit 22 then performs processing (5) below.

MAC(Kmac, c)→tag (5)

In this processing, no tampering of c results in a match between the tag added to the delivery file data 101 and the tag calculated by processing (5). Thus, if these tags do not match, the ladder program inverse transformation unit 22 determines that the ladder program 42 is an unauthorized program. Otherwise, if there is a match between these tags, the ladder program inverse transformation unit 22 determines that the ladder program 42 is a normal program. That is, if there is a match between these tags, the ladder program inverse transformation unit 22 determines that the delivery file data 101 is a file operable on the programmable controller 30A. The ladder program inverse transformation unit 22 then identifies the delivery file data 101 as being untampered. The ladder program inverse transformation unit 22 further performs processing (6) below using a decode function Dec associated with the Enc.

Dec(Kenc, c)→m (6)

Thus, the ladder program inverse transformation unit 22 obtains the ladder program 42 by decoding. Restoration of the ladder program 42 by the decoding performed by the engineering tool 21A as described above enables the user to edit the ladder program 42 and to simulate the ladder program 42. Note that a security function described in Patent Literature 1, i.e., Japanese Patent Application Laid-open No. H10-124308, may be performed at this stage.

The ladder program inverse transformation unit 22 sends the ladder program 42 generated by decoding to the transformation-into-executable-format unit 23. The transformation-into-executable-format unit 23 then transforms the ladder program 42 into the executable file 201 and sends the executable file 201 to the ladder program re-transformation unit 24.

Then, the ladder program re-transformation unit 24 transforms the executable file 201 into a file operable on only the programmable controller 30A associated with the license certificate 41. That is, the ladder program re-transformation unit 24 performs processing (7) to processing (9) below using a tamper detection key K′mac and an encryption key K′enc, where P1 represents the controller public key Cpub indicated in the license certificate 41 and v represents the engineering environment private key Esec. Note that the executable file 201 is here represented by m′. In addition, c′ represents the file generated by encrypting the executable file 201 using the encryption key K′enc, and tag′ represents the tamper detection code generated by applying the tamper detection key K′mac to c′.

KDF(vP1)→K′mac∥K′enc (7)

Enc(K′enc, m′)→c′ (8)

MAC(K′mac, c′)→tag′ (9)

The ladder program re-transformation unit 24 uses c′∥tag′ as the protected executable file 202. The development PC 20 then outputs the protected executable file 202 to the programmable controller 30A.

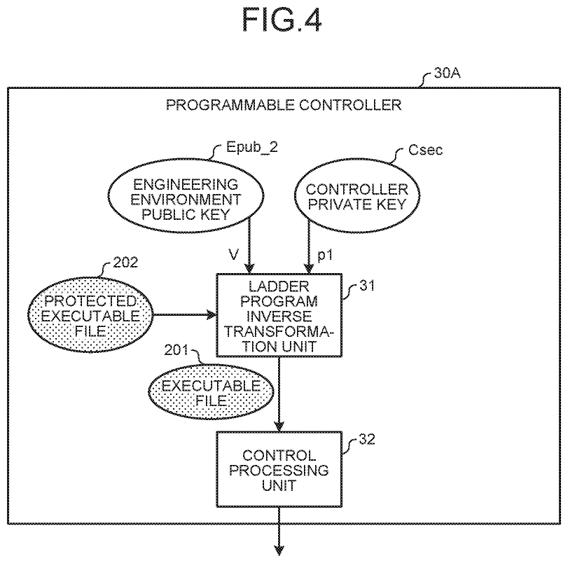

An example configuration of the programmable controller 30A will next, be described. FIG. 4 is a block diagram illustrating an example configuration of the programmable controller according to the first embodiment. The programmable controller 30A includes a ladder program inverse transformation unit 31, which is a determination unit that determines whether the protected executable file 202 is operable thereon, and if operable, inverse-transforms the protected executable file 202 into the executable file 201 that is executable in a control processing unit 32. The ladder program inverse transformation unit 31 performs a second inverse transformation on the protected executable file 202 using the engineering environment public key Epub_2 and the controller private key Csec. The programmable controller 30A further includes the control processing unit 32 that controls the control target device using the executable file 201.

The programmable controller 30A further includes a memory (not illustrated) that stores the engineering environment public key Epub_2 and the controller private key Csec. The engineering environment public key Epub_2 forms a pair with the engineering environment private key Esec.

An operation of the programmable controller 30A will next be described. The programmable controller 30A preparatorily stores the protected executable file 202 sent from the engineering tool 21A in the memory (not illustrated).

Then, the ladder program inverse transformation unit 31 of the programmable controller 30A inverse-transforms the protected executable file 202 sent from the engineering tool 21A into the executable file 201 that is executable in the control processing unit 32. In this operation, the ladder program inverse transformation unit 31 performs inverse transformation, i.e., decoding, using the engineering environment public key Epub_2 and the controller private key Csec each stored in the memory included in the programmable controller 30A. That is, because a relationship of vP1=p1V holds, where V represents the correct engineering environment public key Epub and p1 represents the controller private key Csec, the ladder program inverse transformation unit 31 performs processing (10) below.

KDF(p1V)→K′mac∥K′enc (10)

Thus, the ladder program inverse transformation unit 31 reproduces the encryption key K′enc and the tamper detection key K′mac generated by the engineering tool 21A. The ladder program inverse transformation unit 31 then performs processing (11) below.

MAC(K′mac, c′)→tag′ (11)

In this processing, no tampering of c′ results in a match between the tag′ added to the protected executable file 202 and the tag′ calculated by processing (11). Thus, if these tag′s do not match, the ladder program inverse transformation unit 31 determines that the ladder program 42 is an unauthorized program. Otherwise, if there is a match between these tag′s, the ladder program inverse transformation unit 31 determines that the ladder program 42 is a normal program. That is, if there is a match between these tag′s, the ladder program inverse transformation unit 31 determines that the protected executable file 202 is a file operable on the programmable controller 30A. The ladder program inverse transformation unit 31 then identifies the protected executable file 202 as being untampered. The ladder program inverse transformation unit 31 further performs processing (12) below using the decode function Dec associated with the Enc.

Dec(K′enc, c′)→m′ (12)

Thus, the ladder program inverse transformation unit 31 decodes the protected executable file 202. The ladder program inverse transformation unit 31 sends the executable file 201 restored by decoding to the control processing unit 32. The control processing unit 32 then controls the control target device using the executable file 201. Restoration of the executable file 201 by the programmable controller 30A as described above enables the programmable controller 30A to execute the executable file 201.

Note that when the engineering tool 21A requests the programmable controller 30A to read a file, the programmable controller 30A outputs, to the engineering tool 21A, the protected executable file 202 rather than the executable file 201 restored by decoding.

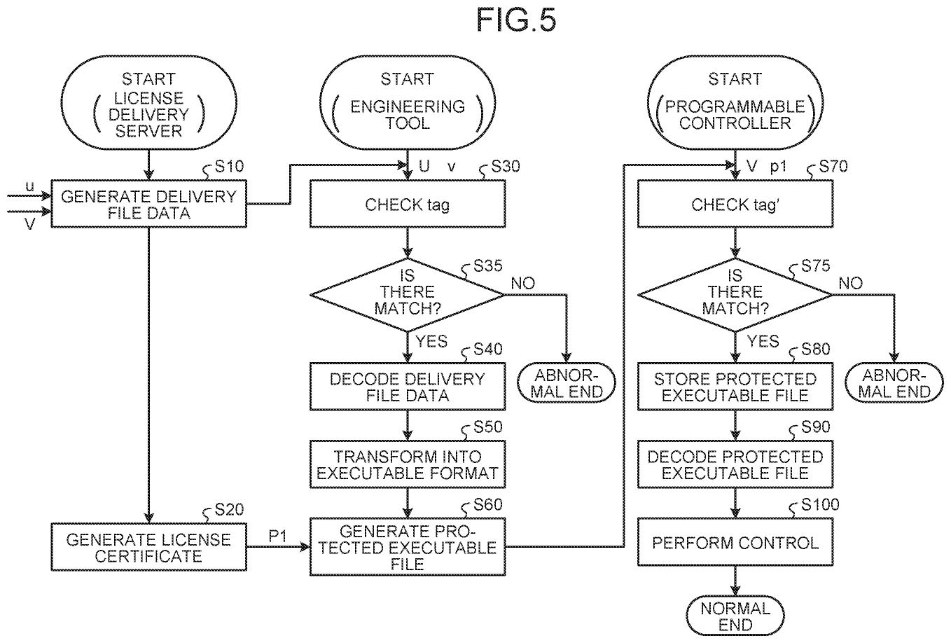

An operation procedure performed by the ladder program unauthorized-use prevention system 1 will next be described. FIG. 5 is a flowchart illustrating an operation procedure performed by the ladder program unauthorized-use prevention system according to the first embodiment.

<License Delivery Server 10A>

At step S10, the license delivery server 10A encrypts the ladder program 42 using u representing the vendor private key Vsec and V representing the engineering environment public key Epub_1, and thus generates the delivery file data 101. Then, at step S20, the license delivery server 10A generates the license certificate 41 for the user on the basis of the public key pair in the public key pair DB 11 and the user information in the user DB 12.

<Engineering Tool 21A>

The engineering tool 21A obtains the delivery file data 101 generated by the license delivery server 10A from the license delivery server 10A. Then, at step S30, the engineering tool 21A checks the tag of the delivery file data 101 generated by the license delivery server 10A using U representing the vendor public key Vpub and v representing the engineering environment private key Esec.

Then, at step S35, the engineering tool 21A determines whether there is a match between the tag added to the delivery file data 101 and the tag calculated by the engineering tool 21A.

If no match is found between the tag added to the delivery file data 101 and the tag calculated by the engineering tool 21A, that is, No at step S35, the engineering tool 21A aborts the process deeming the delivery file data 101 to be tampered.

Otherwise, if there is a match between the tag added to the delivery file data 101 and the tag calculated by the engineering tool 21A, that is, Yes at step S35, the engineering tool 21A decodes the delivery file data 101 at step S40. Thus, the engineering tool 21A restores the ladder program 42. Restoration of the ladder program 42 by the engineering tool 21A enables the user to edit the ladder program 42 and to simulate the ladder program 42. As used herein, the term “to simulate” refers to execution of the ladder program 42 on software.

After the restoration of the ladder program 42, at step S50, the engineering tool 21A transforms the ladder program 42 into an executable format to embed the ladder program 42 the programmable controller 30A. Specifically, the engineering tool 21A transforms the ladder program 42 into the executable file 201.

The engineering tool 21A also obtains the license certificate 41 generated by the license delivery server 10A from the license delivery server 10A. Then, at step S60, the engineering tool 21A encrypts the executable file 201 using P1 representing the controller public key Cpub registered in the license certificate 41, and thus generates the protected executable file 202.

<Programmable Controller 30A>

The programmable controller 30A obtains the protected executable file 202 from the engineering tool 21A. Then, at step S70, the programmable controller 30A checks the tag′ of the protected executable file 202 using V representing the engineering environment public key Epub_2 and p1 representing the controller private key Csec.

At step S75, the programmable controller 30A determines whether there is a match between the tag′ added to the protected executable file 202 and the tag′ calculated by the programmable controller 30A.

If no match is found between the tag′ added to the protected executable file 202 and the tag′ calculated by the programmable controller 30A, that is, No at step 575, the programmable controller 30A aborts the process deeming the protected executable file 202 to be tampered or deeming the protected executable file 202 to be a file intended for a programmable controller other than the programmable controller 30A.

Otherwise, if there is a match between the tag′ added to the protected executable file 202 and the tag′ calculated by the programmable controller 30A, that is, Yes at step S75, the programmable controller 30A stores the protected executable file 202 at step S80.

At step S90, the programmable controller 30A decodes the protected executable file 202. Thus, the engineering tool 21A restores the executable file 201. Then, at step S100, the programmable controller 30A controls the control target device using the executable file 201 and then normally terminates the process.

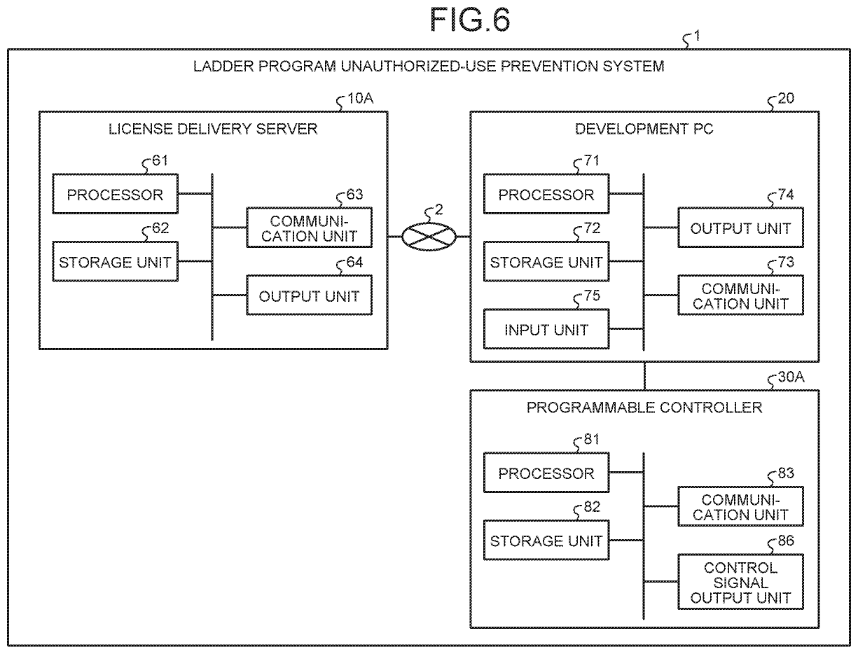

A hardware configuration of the ladder program unauthorized-use prevention system 1 will next be described. FIG. 6 is a diagram illustrating a hardware configuration of the ladder program unauthorized-use prevention system according to the first embodiment.

The license delivery server 10A of the ladder program unauthorized-use prevention system 1 includes a processor 61, a storage unit 62, a communication unit 63, and an output unit 64. In the license delivery server 10A, the processor 61, the storage unit 62, the communication unit 63, and the output unit 64 are connected to a bus.

The communication unit 63 communicates with the development PC 20 via the Internet 2. Note that the communication unit 63 may communicate with a device other than the development PC 20. In a case in which the license delivery server 10A provides the license certificate 41 to the user online, the communication unit 63 sends the license certificate 41 to the development PC 20 via the Internet 2. Also, in a case in which the license delivery server 10A provides the delivery file data 101 to the user online, the communication unit 63 sends the delivery file data 101 to the development PC 20 via the Internet 2.

The output unit 64 outputs information in the license delivery server 10A to an external device. In a case in which the license delivery server 10A provides the license certificate 41 to the user by mail, the output unit 64 outputs data of the license certificate 41 generated by the license certificate generation unit 13 to an external device such as a printer. The output unit 64 may also write the data of the license certificate 41 into the portable recording medium 43 such as a DVD. The output unit 64 may also write the delivery file data 101 into the recording medium 43.

The storage unit 62 includes the public key pair DB 11 and the user DB 12. The storage unit 62 stores the vendor private key Vsec, the engineering environment public key Epub_1, and the ladder program 42. The storage unit 62 also stores a program for performing the processing of the license certificate generation unit 13 and a program for performing the processing of the ladder program transformation unit 14. The storage unit 62 further stores the license certificate 41, which is a result of the processing of the license certificate generation unit 13, and the delivery file data 101, which is a result of the processing of the ladder program transformation unit 14.

The license delivery server 10A is implemented by the processor 61 by reading and executing a program stored in the storage unit 62 for providing an operation of the license delivery server 10A. It can also be said that this program causes the computer to perform a procedure or method of the license delivery server 10A. The processor 61 of the first embodiment uses various programs to perform the processings of the license certificate generation unit 13 and of the ladder program transformation unit 14. The storage unit 62 is also used as a temporary memory in performing various processings by the processor 61.

Thus, programs executed by the processor 61 are a computer program product contained in a non-transitory computer-readable recording medium, including multiple computer-executable instructions for performing data processing. The multiple instructions of a program executed by the processor 61 cause the computer to perform data processing.

In the license delivery server 10A, the function of the license certificate generation unit 13 or the ladder program transformation unit 14 may be implemented in a dedicated hardware element. Alternatively, the functions of the license delivery server 10A may be implemented partly in a dedicated hardware element and partly in software or firmware.

The development PC 20 of the ladder program unauthorized-use prevention system 1 includes a processor 71, a storage unit 72, a communication unit 73, an output unit 74, and an input unit 75. In the development PC 20, the processor 71, the storage unit 72, the communication unit 73, the output unit 74, and the input unit 75 are connected to a bus. The input unit 75 receives the delivery file data 101 and the license certificate 41 sent from an external device, and inputs the delivery file data 101 and the license certificate 41 to the storage unit 72.

The communication unit 73 has functions similar to the functions of the communication unit 63. The output unit 74 has functions similar to the functions of the output unit 64. The communication unit 73 communicates with the license delivery server 10A via the Internet 2. Note that the communication unit 73 may communicate with a device other than the license delivery server 10A. In a case in which the license delivery server 10A provides the license certificate 41 to the user online, the communication unit 73 receives the license certificate 41 via the Internet 2. Also, in a case in which the license delivery server 10A provides the delivery file data 101 to the user online, the communication unit 73 receives the delivery file data 101 via the Internet 2.

The output unit 74 writes the protected executable file 202 into the portable recording medium 43 such as a universal serial bus (USB) memory. In this case, the recording medium 43 containing the protected executable file 202 written therein, is connected to the programmable controller 30A. The programmable controller 30A then reads the protected executable file 202 written into the recording medium 43. Note that the communication unit 73 may instead send the protected executable file 202 to the programmable controller 30A. In this case, the communication unit 73 uses, for example, Ethernet (registered trademark) communication for the communication. The protected executable file 202 sent to the programmable controller 30A through the output unit 74 or through the communication unit 73 is then stored in a storage unit 62, described later, of the programmable controller 30A.

The processor 71 has functions similar to the functions of the processor 61. The storage unit 72 has functions similar to the functions of the storage unit 62. The storage unit 72 stores the vendor public key Vpub and the engineering environment private key Esec. The vendor public key Vpub and the engineering environment private key Esec used in this process are non-user-editable information. The storage unit 72 also stores the delivery file data 101 and the license certificate 41. The storage unit 72 further stores programs for performing the processings of the ladder program inverse transformation unit 22, of the transformation-into-executable-format unit 23, and of the ladder program re-transformation unit 24. The storage unit 72 also stores the ladder program 42, which is a result of the processing of the ladder program inverse transformation unit 22, the executable file 201, which is a result of the processing of the transformation-into-executable-format unit 23, and the protected executable file 202, which is a result of the processing of the ladder program re-transformation unit 24.

The development PC 20 is implemented by the processor 71 by reading and executing a program stored in the storage unit 72 for providing an operation of the development PC 20. It can also be said that this program causes the computer to perform a procedure or method of the development PC 20. The development PC 20 runs the engineering tool 21A, which is an application program, by the processor 71. The processor 71 of the first embodiment uses the engineering tool 21A, which is one o the programs included in the development PC 20, to perform the processings of the ladder program inverse transformation unit 22, of the transformation-into-executable-format unit 23, and of the ladder program re-transformation unit 24. The storage unit 72 is also used as a temporary memory in performing various processings by the processor 71.

Thus, programs executed by the processor 71 are a computer program product contained in a non-transitory computer-readable recording medium, including multiple computer-executable instructions for performing data processing. The multiple instructions of a program executed by the processor 71 cause the computer to perform data processing.

In the development PC 20, the function of the ladder program inverse transformation unit 22, the transformation-into-executable-format unit 23, or the ladder program re-transformation unit 24 may be implemented in a dedicated hardware element. Alternatively, the functions of the development PC 20 may be implemented partly in a dedicated hardware element and partly in software or firmware.

The programmable controller 30A of the ladder program unauthorized-use prevention system 1 includes a processor 81, the storage unit 82, a communication unit 83, and a control signal output unit 86. In the programmable controller 30A, the processor 81, the storage unit 82, the communication unit 83, and the control signal output unit 86 are connected to a bus.

The communication unit 83 communicates with the communication unit 73. The communication unit 83 receives the protected executable file 202 sent from the communication unit 73. The communication unit 83 uses, for example, Ethernet communication for the communication. The communication unit 83 stores the protected executable file 202 received from the communication unit 73 in the storage unit 82. Note that the communication unit 83 may communicate with a device other than the development PC 20. The control signal output unit 86 outputs instructions corresponding to the executable file 201 to the control target device. The control signal output unit 86 outputs, to the control target device, a signal value, which is the result of processing by the control processing unit 32 described above.

The processor 81 has functions similar to the functions of each of the processors 61 and 71. The storage unit 82 has functions similar to the functions of each of the storage units 62 and 72. The storage unit 82 stores the engineering environment public key Epub_2, the controller private key Csec, and the protected executable file 202. The storage unit 82 also stores programs for performing the processings of the ladder program inverse transformation unit 31 and of the control processing unit 32. The storage unit 82 further stores the executable file 201, which is a result of the processing of the ladder program inverse transformation unit 31.

The programmable controller 30A is implemented by the processor 81 by reading and executing a program stored in the storage unit 82 for providing an operation of the programmable controller 30A. It can also be said that this program causes the computer to perform a procedure or method of the programmable controller 30A. The processor 81 of the first embodiment uses programs to perform the processings of the ladder program inverse transformation unit 31 and of the control processing unit 32. The storage unit 82 is also used as a temporary memory in performing various processings by the processor 81.

Thus, programs executed by the processor 81 are a computer program product contained in a non-transitory computer-readable recording medium, including multiple computer-executable instructions for performing data processing. The multiple instructions of a program executed by the processor 81 cause the computer to perform data processing.

In the programmable controller 30A, the function of the ladder program inverse transformation unit 31 or the control processing unit 32 may be implemented in a dedicated hardware element. Alternatively, the functions of the programmable controller 30A may be implemented partly in a dedicated hardware element and partly in software or firmware.

The processors 61, 71, and 81 are each a central processing unit (CPU) (also referred to as processing unit, computing unit, microprocessor, microcomputer, processor, digital signal processor (DSP)), a system large scale integration (LSI), or the like.

The storage units 62, 72, and 82 may each be a non-volatile or volatile semiconductor memory such as a random access memory (RAM), a read-only memory (ROM), or a flash memory, or may be a magnetic disk or a flexible disk.

Supplying the packaged product including, in combination, the programmable controller 30A, the ladder program 42, and the peripheral device in a bundle to the user can reduce the setting-up time of the production line used by the user. Such a packaged product allows an unauthorized user to use the ladder program 42 of other users unless restriction is imposed on use of the ladder program 42. Thus, in the first embodiment, the license delivery server 10A performs encryption on a per-user basis, and the engineering tool 21A performs encryption for each programmable controller 30A. In the first embodiment, this ensures security of the packaged product under the limiting conditions described above. This can prevent unauthorized browsing, editing, copying, and executing of the ladder program 42 in the packaged product.

Thus, the ladder program unauthorized-use prevention system 1 transforms, by the license delivery server 10A, the ladder program 42 to be protected, into the delivery file data 101 having a format decodable by only the authorized engineering tool 21A. This can protect the ladder program 42 in the delivery file data 101 even if the delivery file data 101 to be delivered to the authorized engineering tool 21A is leaked out.

In addition, the engineering tool 21A performs encryption using the license certificate 41 delivered from the license delivery server 10A, and can thus transform the ladder program 42 to a file operable on only the specific programmable controller 30A. Thus, the engineering tool 21A can protect the ladder program 42 from abuse such as a case in which the ladder program 42 used, without authorization, by another programmable controller.

As described above, in the first embodiment, the engineering tool 21A performs various processings on the ladder program 42 that has been encrypted using the engineering environment public key Epub_1, and then encrypts, using the controller public key Cpub, the ladder program 42 that has been processed, to be operable on the programmable controller 30A, but be inoperable on other programmable controllers. The programmable controller 30A then determines whether the ladder program 42 that has been encrypted using the controller public key Cpub is operable on that programmable controller 30A. Thus, the ladder program 42 generated for the programmable controller 30A is operable on the programmable controller 30A, but is inoperable on other programmable controllers. This can prevent unauthorized use of the ladder program 42 delivered from the license delivery server 10A.

In addition, the engineering tool 21A encrypts the ladder program 42 on the basis of the license certificate 41 for the programmable controller 30A. This can prevent decoding of the ladder program 42 by a programmable controller other than the programmable controller 30A.

Moreover, the engineering tool 21A determines whether the ladder program 42 is an unauthorized program or not, and the programmable controller 30A determines whether the ladder program 42 is an unauthorized program or not. This enables tampering of the ladder program 12 to be easily detected.

### Second Embodiment

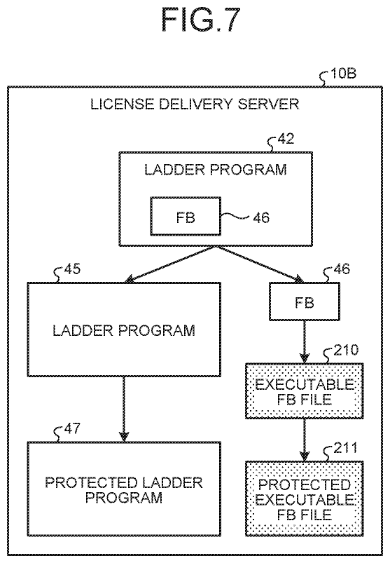

A second embodiment will next be described with reference to FIGS. 7 to 9. To prevent unauthorized use of the ladder program 42, a license delivery server 10B described later separates the function block from the ladder program 42, and encrypts the function block to prevent the function block from being restored by an engineering tool 21B described later.

FIG. 7 is a diagram for describing a process performed by the license delivery server according to the second embodiment. The license delivery server 10B has functions similar to the functions of the license delivery server 10A described in the first embodiment. The ladder program transformation unit 14 of the license delivery server 10B separates the ladder program 42 containing a function block FB 46 into a ladder program 45 without the FB 46, and the FB 46. In other words, the ladder program transformation unit 14 separates the ladder program 42 into first and second segments.

The ladder program transformation unit 14 transforms the first segment, i.e., the ladder program 45, into a protected ladder program 47 in a manner similar to the first embodiment. Specifically, the ladder program transformation unit 14 transforms the ladder program 45 into the protected ladder program 47 by a process similar to the process of generating the delivery file data 101 from the ladder program 42.

The ladder program transformation unit 14 also transforms the second segment, i.e., the PB 46, to an executable format to generate an executable FB file 210. The executable PB file 210 is an executable file operable on the programmable controller 30A resulting from transformation of the FB 46. In other words, similar to the executable file 201 of the first embodiment, the executable FB file 210 is an executable file recognized by the programmable controller 30A as a program.

In addition, the ladder program transformation unit 14 performs an encryption operation intended for the programmable controller 30A on the executable FB file 210. That is, in contrast to the first embodiment, in which the engineering tool 21A performs encryption intended for the programmable controller 30A, the encryption operation is performed in the second embodiment by the ladder program transformation unit 14. Thus, in the second embodiment, the license delivery server 10B encrypts the executable FB file 210 thus to generate a protected executable FB file 211 before delivery of the ladder program 42 to the user.

The protected executable FB file 211 is a file operable on only the programmable controller 30A resulting from transformation of the executable FB file 210. The license delivery server 10B delivers both the protected ladder program 47 and the executable FB file 210 generated, to the user.

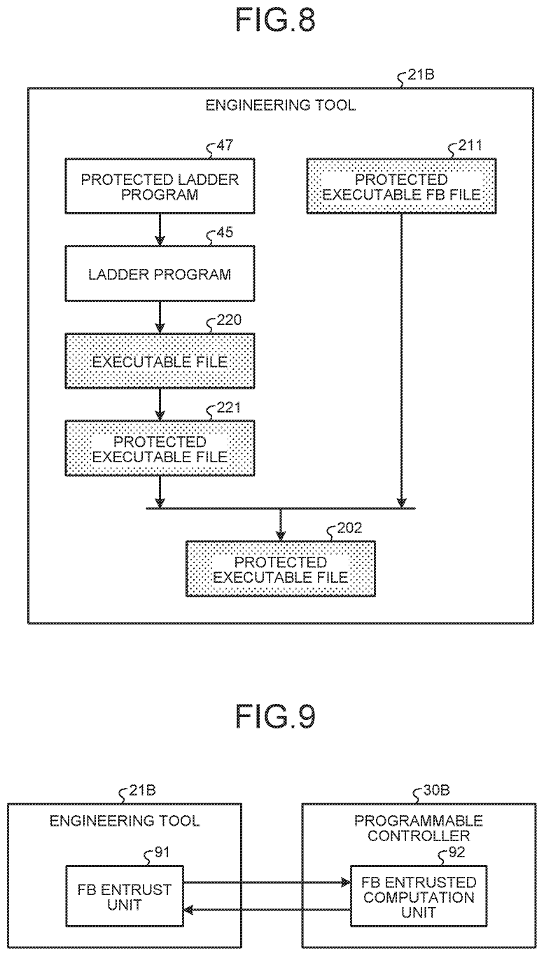

FIG. 8 is a diagram for describing a process performed by an engineering tool according to the second embodiment. The engineering tool 21B has functions similar to the functions of the engineering tool 21A described in the first embodiment, and thus restores the protected ladder program 47 in a manner similar to the first embodiment. That is, the engineering tool 21B restores the ladder program 45 from the protected ladder program 47 by a process similar to the process of restoring the ladder program 42 from the delivery file data 101. Specifically, the ladder program inverse transformation unit 22 of the engineering tool 21B inverse-transforms the protected ladder program 47 into the ladder program 45 before encryption This enables the engineering tool 21B to achieve a restoration result similar to that of the first embodiment with respect to the ladder program 45 without the PB 46. This causes the program part other than the FB 46 to be editable by the engineering tool 21B. Note that because the FB 46 is in a protected format, the engineering tool 21B cannot perform a simulation unless a certain appropriate processing is performed. Processing for allowing the engineering tool 21B to perform a simulation will be described later herein.

Then, the transformation-into-executable-format unit 23 transforms the ladder program 45 generated by the ladder program inverse transformation unit 22 by an inverse transformation into an executable file 220. Similiarly to the executable file 201 of the first embodiment, the executable file 220 in this process is an executable file recognized by the programmable controller 30A as a program. The ladder program re-transformation unit 24 then transforms the executable file 220 generated by the transformation-into-executable-format unit 23 into a protected executable file 221 operable on only the programmable controller 30A associated with the license certificate 41. Similarly to the protected executable file 202 of the first embodiment, the protected executable file 221 in this process is a file protected such that it cannot be operated in a programmable controller other than the programmable controller 30A.

The ladder program re-transformation unit 24 concatenates together the protected executable file 221 and the protected executable FB file 211. Thus, the ladder program re-transformation unit 24 can obtain the protected executable file 202 equivalent to the protected executable file 202 described in the first embodiment. Then, the development PC 20 sends the protected executable file 202 to the programmable controller 30A, and the programmable controller 30A then controls the control target device using the protected executable file 202.

A simulation process of the FB 46 performed by the engineering tool 21B of the second embodiment will next be described. FIG. 9 is a diagram for describing a simulation process of the FB performed by the engineering tool according to the second embodiment. As used herein, the phrase “simulation process of the FB 46” refers to execution of the FB 46 on software.

The engineering tool 21B according to the second embodiment includes an FB entrust unit 91. In a case in which the engineering tool 21B performs a simulation process of the FB 46, a programmable controller 30B is used in place of the programmable controller 30A. The programmable controller 30B further includes an FB entrusted computation unit 92 in addition to the functions included in the programmable controller 30A.

The FB entrust unit 91 has a function to, upon reception of a simulation request for simulation of the FB 46 from the user, output the simulation request to the programmable controller 30B. Thus, when the user makes a simulation request for simulation of the FB 46, the FB entrust unit 91 accepts the simulation request, and transfers the accepted simulation request to the FB entrusted computation unit 92 of the programmable controller 30B.

The FB entrusted computation unit 92 computes processing in the FB 46 on the basis of the simulation request from the FB entrust unit 91. That is, the FB entrusted computation unit 92 computes an output of the FB 46 corresponding to the input from the FB entrust unit 91. The FB entrusted computation unit 92 sends a computation result, which is a simulation result of the processing using the FB 46, to the FB entrust unit 91. As described above, the FB entrust unit 91 requests the FB entrusted computation unit 92 to perform a simulation using the FB 46, and the FB entrusted computation unit 92 performs a simulation using the FB 46 and returns the simulation result to the FB entrust unit 91.

This enables the engineering tool 21B to perform a simulation without restoration of the FB 46 in the engineering environment. Addition of such functions of the FB entrust unit 91 and of the FB entrusted computation unit 92 to the ladder program unauthorized-use prevention system 1 described in the first embodiment enables the ladder program 42 of the programmable controller 30B to be developed in the ladder program unauthorized-use prevention system 1 without restoration of the FB 46 in the engineering environment. Thus, the ladder program unauthorized-use prevention system 1 can provide reliable protection to the FE 46 in the packaged product.

Thus, according to the second embodiment, protection of the FE 46 prevents restoration of the FB 46 even if the engineering tool 21B has restored the ladder program 45. This can prevent stealing of information on the keys used in restoration and the FB 46 even if the engineering tool 21B is reverse engineered.

The configurations described in the foregoing embodiments are merely examples of various aspects of the present invention. These configurations may be combined with a known other technology, and moreover, part of such configurations may be omitted and/or modified without departing from the spirit of the present invention.

### REFERENCE SIGNS LIST

1 ladder program unauthorized-use prevention system; 10A, 10B license delivery server; 11 public key pair DB; 12 user DB; 13 license certificate generation unit; 14 ladder program transformation unit; 20 development PC; 21A, 21B engineering tool; 22 ladder program inverse transformation unit; 23 transformation-into-executable-format unit; 24 ladder program re-transformation unit; 30A, 30B programmable controller; 31 ladder program inverse transformation unit; 32 control processing unit; 41 license certificate; 42, 45 ladder program; 91 FB entrust unit; 92 FB entrusted computation unit; 101 delivery file data; 201, 220 executable file; 202, 221 protected executable file; 210 executable FB file; 211 protected executable FB file.

1. A ladder program unauthorized-use prevention system comprising:
an engineering tool to perform a first inverse transformation on a ladder program that undergoes a first transformation using first private information, using first public information paired with the first private information, and perform a second transformation, using second public information, on the ladder program that undergoes the first inverse transformation such that the ladder program is operable on a specific programmable controller but is inoperable on a programmable controller other than the specific programmable controller; and
a programmable controller to perform a second inverse transformation on the ladder program that undergoes the second transformation, using second private information paired with the second public information, and execute the ladder program that undergoes the second inverse transformation.

2. The ladder program unauthorized-use prevention system according to claim 1, wherein the engineering tool performs the second transformation on a basis of information on license for the specific programmable controller.

3. The ladder program unauthorized-use prevention system according to claim 1, wherein
the engineering tool determines whether the ladder program that undergoes the first transformation is an unauthorized program or not, and
the programmable controller determines whether the ladder program that undergoes the second transformation is an unauthorized program or not.

4. The ladder program unauthorized-use prevention system according to claim 1, wherein the engineering tool performs the first inverse transformation on the ladder program that undergoes the first transformation, and performs the second transformation on the ladder program that is restored using the first inverse transformation.

5. The ladder program unauthorized-use prevention system according to claim 3, wherein the programmable controller performs the second inverse transformation on the ladder program that undergoes the second transformation to restore the ladder program, makes the determination on the restored ladder program, and, in a case in which the ladder program is operable, controls a control target device using the restored ladder program.

6. The ladder program unauthorized-use prevention system according to claim 1, wherein
the ladder program includes first and second segments,
the first segment is encrypted to be decodable by the engineering tool, and
the second segment is encrypted to be undecodable by the engineering tool but decodable by the programmable controller.

7. The ladder program unauthorized-use prevention system according to claim 6, wherein
the engineering tool requests the programmable controller to perform a simulation using the second segment, and
the programmable controller performs the simulation using the second segment and returns a simulation result to the engineering tool.

8. The ladder program unauthorized-use prevention system according to claim 2, wherein the first transformation is performed in a license delivery server that generates the information on the license and provides the information on the license to the engineering tool.

9. The ladder program unauthorized-use prevention system according to claim 2, wherein the information on the license is information generated using a public key pair that is a pair of the second public information and the second private information.

10. A ladder program unauthorized-use prevention system comprising:
a license delivery server to perform a first transformation on a ladder program using first private information;
an engineering tool to perform a first inverse transformation on the ladder program that undergoes the first transformation, using first public information paired with the first private information, and perform a second transformation, using second public information, on the ladder program that undergoes the first inverse transformation such that the ladder program is operable on a specific programmable controller but is inoperable on a programmable controller other than the specific programmable controller; and
a programmable controller to perform a second inverse transformation on the ladder program that undergoes the second transformation, using second private information paired with the second public information, and execute the ladder program that undergoes the second inverse transformation.

11. A ladder program unauthorized-use prevention method comprising:
performing a first inverse transformation, using first public information, on a ladder program that undergoes a first transformation using first private information;
performing a second transformation, using second public information, on the ladder program that undergoes the first inverse transformation such that the ladder program is operable on a specific programmable controller but is inoperable on a programmable controller other than the specific programmable controller; and
performing a second inverse transformation on the ladder program that undergoes the second transformation, using second private information, and of executing the ladder program that undergoes the second inverse transformation.

12-14. (canceled)
